(19) United States
(12) Patent Application Publication
(10) Pub. No.: US 2011/0313897 A1
(43) Pub. Date: Dec. 22, 2011

(54) PAY GROUP

(75) Inventors: Bhaskara Rao Mulakaluri, Foster City, CA (US); Kushal Chatterjee, Santa Clara, CA (US)

(73) Assignee: eBay Inc., San Jose, CA (US)

(21) Appl. No.: 12/819,036

(22) Filed: Jun. 18, 2010

(51) Int. Cl. G06Q 20/00; G06Q 10/00; G06F 15/16; G06Q 40/00

(52) U.S. Cl. 705/30; 705/39; 709/206

(57) ABSTRACT

In one embodiment, a group account is provided to enable group members to make and receive payments, form different groups, easily track activities within a group, and manage group financial-based transactions. An administrator, who may also be a group member, creates a group through a payment provider service. The administrator invites individuals to be part of the group. Once the group is formed through individuals who accept the invitation, group members will be able to view information about the group as well as engage in financial transactions through and within the group using a group account.

### BACKGROUND

1. Field of the Invention

The present invention generally relates to on-line financial transactions, and in particular, to on-line financial groups.

2. Related Art

Social and group sites on the Internet, such as Facebook™, are becoming increasingly popular. Such sites allow individuals to be part of a group and gives individuals a more social experience from their computing devices, even when sitting at home or in an office. The groups can range in size from just a few members up to thousands or more. Chat rooms also provide a social setting for individuals to discuss specific topics or among known group members.

Another area of growth on the Internet is financial transactions between parties or individuals, such as merchants and consumers. Typically, a consumer will browse the Internet, locate an item or service for purchase, and make a payment for the purchase through a payment provider, such as PayPal, Inc. of San Jose, Calif. Financial transactions can also be made between individuals, such for a purchase, a gift (e.g., from parent to child), a loan, or a re-payment of a loan. However, conventionally payments made on-line are typically between two parties, with little or no social aspect or involvement with others.

Thus, it would be desirable to give on-line users a forum to engage in financial transactions in a group setting.

### SUMMARY

In accordance with different embodiments, a group account is provided to enable group members to make and receive payments, form different groups, easily track activities within a group, and manage group financial-based transactions. In one embodiment, an administrator, who may also be a group member, creates a group through a payment provider service, such as PayPal. The administrator invites individuals to be part of the group. Once the group is formed through individuals who accept the invitation, group members will be able to view information about the group as well as engage in financial transactions through and within the group.

In one embodiment, the group administrator can request money from group members or distribute money to group members or the group as a whole. To request money, the administrator may request equal payment amounts from all the group members or from select group members or different payment amounts from different group members. The request is then transmitted, such as via email, text, or other means, to the selected group members. The request may contain information about the payment request, the amount requested, and instructions or a link to make the payment. Group members may make payments into the group account through the payment provider or other funding source. The received payments into the group account can be viewed and tracked, such as by the administrator and possibly group members.

To distribute money, the administrator sends a notice to selected group members that a payment has been made to an individual or to the group account. The notice may contain similar information as a request money message. Notified group members may retrieve the payment through the payment provider or simply view the group account with the newly deposited funds.

In different embodiments, the group account may also be used to make purchases or send money on behalf of the group. For example, the administrator may use group funds to make a payment to a merchant or donate money to a charity through the group account. Again, group members may be able to view activity of the group account.

In one embodiment, the group members are required to have an account with the payment provider. If an invited individual does not have an account, the individual will be asked to create an account before given access to the group account.

There are numerous advantages to both a payment provider and consumers with such a group financial account, managed through a payment provider. For example, new users may sign up with the payment provider to utilize the group account, payments handled through the payment provider may increase due to group use, and visibility for the payment provider may increase due to the social nature of the group. For consumers, the group account enables users to interact in a more social setting while engaging in financial transactions, thereby making it more enjoyable for the user, and provides users with an easier way to perform financial transactions within a group or for a group.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process for a payment provider in handling a group financial account according to one embodiment;

FIG. 2 is a flowchart showing a process for creating a group financial account according to one embodiment;

FIGS. 3A-3C are flowcharts showing different functions of the group financial account according to various embodiments;

FIGS. 4A-4H are exemplary screen shots seen by a user for creating and administering a financial group account according to one embodiment;

FIG. 5 is block diagram of a networked system suitable for implementing the process of FIGS. 1-3 in accordance with embodiments of the invention; and

FIG. 6 is a block diagram of a computer system suitable for implementing one or more components in FIG. 5 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

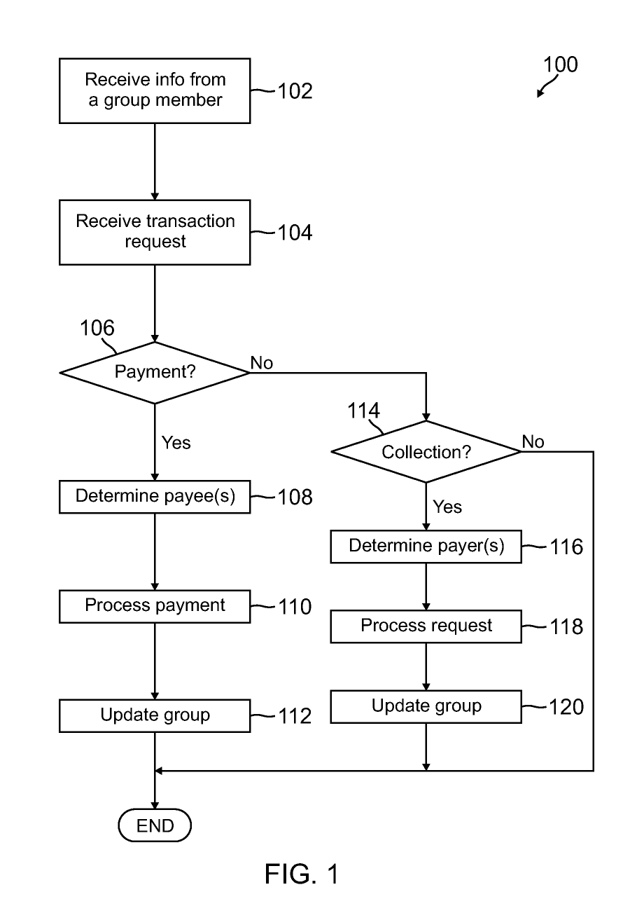

FIG. 1 is a flowchart 100 showing a process for a payment provider in handling a group financial account according to one embodiment. At step 102, information is received from a member of a financial group account. The member can be an administrator of the account, who may or may not also be a user of the account. In other words, the administrator's function may solely be to manage and administer the account. The information is typically received through a wireless transmission, such as from a user device to a payment provider device, although other transmission means may also be suitable. The information may include data about the member and the financial group the member belongs to.

The payment provider also receives, at step 104, a transaction request from the member. The transaction request can be any number of actions for the payment provider to perform on behalf of the requesting member. Examples include, but are not limited to, a request by the member to make one or more payments, receive one or more payments, create a group, edit a profile of a group member, delete one or more group members, invite one or more potential group members, add one or more group members, and delete a group.

After receiving the transaction request, a determination is made at step 106 whether the request is for a payment, e.g., the group or one or more group members requests a payment be made on their behalf. This may be from information conveyed when the member selects a particular link or button for transmitting the request to the payment provider.

If, as determined at step 106, the request from the group member is for a payment, the payment provider identifies the payee(s) at step 108. Again, this may be from information contained in the request, such as information identifying the payee. The information may include an email address, a phone number, a user name, etc.

Once the payee(s) are determined or identified at step 108, the payment provider processes the payment request at step 110. The payee(s) may be users of the group financial account or a third party outside the group, such as a merchant, retailer, charity, individual, or other recipient of funds. The payment provider may notify the identified payee(s), such as by email, text, or other means. The payment provider may obtain this information from the user requesting the payment at step 102, such as the payee(s) email address or phone number. The notification may include a message that a payment is waiting and to create an account with the payment provider to retrieve the payment if the payee does not have an account with the payment provider. If the payee has an account, the notification may be for the user to log into his or her account to receive the payment or simply a message that a payment has been deposited into the payee's account with the payment provider. The person making the payment may also be identified in the notification, along with any other information, such as a description of the payment.

During step 110 and after identifying accounts of one or more payees, the payment provider deducts the appropriate funds from the account of the group member requesting the payment and credits accounts of the payees. If the requesting group member is an administrator requesting the funds be transferred from the group account, the payment provider deducts the funds from the group account, such as if a purchase or payment was made on behalf of the group.

Next, the group may be updated with the activity at step 112. This may include sending a notification to some or all of the group members informing them that a payment was made from the group account, along with the amount and the person that requested/authorized the payment to be made. Updating may, in other embodiments, include updating information in the group account page, such that when group members access the group account, they can see any recent activity with the group account. In the above example, the group members may see that a certain amount of money from the group account was used to pay a specific organization, group, person, retailer, merchant, etc., how much is remaining in the group account, who made the request and/or gave authorization for the payment, the amount of payment, the date of payment, and/or the reason for the payment.

Referring back to step 106, if the determination is made that the transaction request received at step 104 is not for a payment, another determination is made, at step 114, whether the transaction request is for a collection. A collection request may be a request for money from an administrator or a group member to one or more group members. In this case, the transaction request received by the payment provider may include an amount requested and information about the group members subject to the request, as well as an indication that the request is for a collection of money, which may be conveyed by the group member clicking on a specific link or button (e.g., request collection). The amount may be the same or different for different group members. The group member information may include an email address, user name within the group, telephone number, or other identifying information. The request for collection may also include information identifying the account the money is to be deposited into, such as the group account.

If the determination is made that the request is to collect money from one or more members of the group, the payment provider determines who the payers are at step 116. This can be from the transaction request in which payers are identified by email, user name, or phone number by the requester.

Next, the request for collection is processed at step 118. In one embodiment, the payment provider sends a notification to the payers using information of the payers provided by the requester or available in the payment provider system based on information from the requester. Thus, the notification may be sent via email, text, phone message, or other means. The notification may include the amount of requested payment, a reason for the request, who made the request, and how to make the payment. Payment may be made by accessing the payment provider site, such as through a link in the notification. Once on the payment provider site, the payer may select an acceptable funding source, such as a credit card or bank account, and enter the requested information. If the payer has an account with the payment provider, the payer may simply select a pay or confirm option to make the payment after logging into the payer's account.

Processing may then include debiting the appropriate amount for payer accounts and crediting corresponding amounts to the account identified by the requester, e.g., the group financial account.

After processing, the group, administrator, or group members are updated with the latest transaction at step 120, similar to step 112. In one embodiment, the group account is updated as payments are received so that group members and the administrator can see who has been requested to make a payment and for what amount, who has paid, and who has not paid. The requester may be sent a notification any time a payment is received from a payer, and a payer may be sent a notification when a payment by the payer has been processed. The updating or processing step may also include sending reminders to requested payers, such as when the requesting group member also includes a hard or soft date for receiving payments or collections.

Note that the transaction request does not have to be just a payment or a collection. The group member making the request, such as an administrator, may request a new group account be created, a group account be deleted, adding group members, deleting group members, editing information about the group account or the group members, etc. Based on the request, the payment provider performs the appropriate actions.

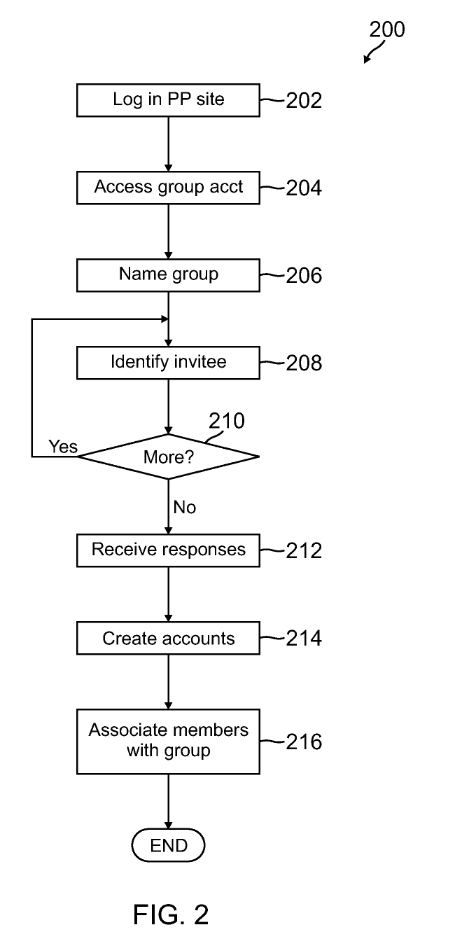

FIG. 2 is a flowchart showing a process 200 for creating a group financial account according to one embodiment. At step 202, a user wishing to create the group account logs into a payment provider site. If the user does not have an account, the user may be asked to create an account before proceeding. Logging may include entering a user identifier, such as a user name or email address, and a password or PIN.

Once logged in, the user may see different options, including accessing a group account. The accessing may include creating, editing, or deleting a group account. The user access the group account at step 204, such as by clicking a link, selecting from a drop-down menu, or selecting a button. Next, the user may be re-directed to a page requesting the user to name the group. The user then enters a group name at step 206, such as by typing in the name in a requested field. The user may be informed whether the name is acceptable or to enter a different group name. Note that naming the group may occur at any time and may also not be required if the payment provider names the group.

Next, the user may enter one or more names of people to be invited as part of the group. At step 208, the user identifies invitees by an email address, a phone number, and/or a user name. The user may also identify invitees by their actual name. Identification should be sufficient so that the payment provider can contact the invitees to inform them of the invitation to joint the group and to then process their response. If the invitee is identified by an email address, the invitee may be contacted by email. If the invitee is identified by a phone number, the invitee may be contacted by text or voice message. If the invitee is identified by a user name, where the user name is associated with an account maintained by the payment provider, the payment provider can use the user name to access contact information and then contact the invitee accordingly.

A determination is made, at step 210, whether there are more invitees to add, such as asking the user whether there are more invitees or whether the user is finished. The user continues to enter information about invitees until there are no more to enter at the time.

At step 212, responses from invitees are received, such as by the user creating the group and/or the payment provider. Responses may be a yes, no, or maybe, such as a “remind me later” response. Responses may be tracked by the payment provider and conveyed to the user creating the group.

These responses may be conveyed by the invitee clicking or selecting a link from the invitation or from the payment provider site. If the invitee does not have an account with the payment provider, the invitee may be asked to create an account in the invitation or based on a positive response to join the group. Creating an account, at step 214, may include receiving the invitee's actual name, a user name, a password, a funding account, such as a credit card or bank account, a billing address, an email, a phone number, date of birth, etc. and then assigning an account number to the invitee and associating the account with user information.

After an invitee has accepted the invitation and has an account with the payment provider (either just created or pre-existing), the new member is associated with the newly created financial group. For example, IDs of the members are linked to the ID of the group account. When users log into their individual accounts, they may see a list of groups to which they now belong. Users may access a group account through their individual accounts.

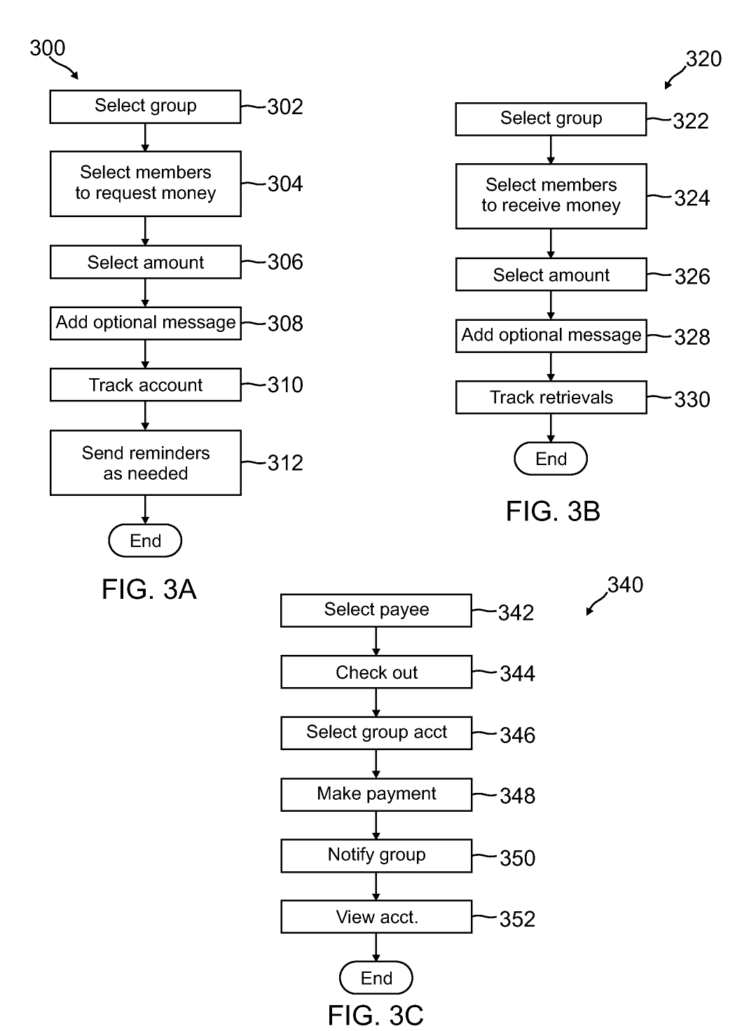

FIGS. 3A-3C are flowcharts showing different functions of the group financial account according to various embodiments. In FIG. 3A, a process 300 is shown for requesting money from group members, such as to make a group purchase or donation, according to one embodiment. First, an administrator or user selects the desired group, at step 302, such as from the user's account or directly logging into the group account. Once the group is selected, the user may be shown a list of group members, which the user may select from at step 304 to request money. Selection may be by simply clicking or checking a box next to the names of the desired invitees or any other suitable means. If all group members will be asked for money, the user may simply perform a “select all” action.

At step 306, the user may select the amount of money requested of the group members. The amount may be the same for all members or different. For example, if the group is planning a purchase or donation of a specific amount, say $500, then the user may enter the specific amount, specify equal payments for the selected group members, and the payment provider could automatically allocate the required amount for each individual. The user may also be able to manually input specific amounts for specific group members.

Before the request is transmitted to the selected group members, a message may be included at step 308. The message may have details of the request, such as the reason, when the money is needed, etc. For example, the user may ask group members to donate to a charity that the group previously agreed upon, make a payment for a group purchase, such as a trip, etc.

Once the request is sent to the group members, the user or other group members may track progress of the request, at step 310, through the group account page or other means, such as email updates. In one embodiment, when a group member makes a payment in response to a request, the user is notified by email and the group account is updated to show that the specific group member has made the requested payment, along with any other information, such as date paid. Being able to track progress of the requests allows the user as well as others in the group to better manage the account and increase the group experience. For example, for the latter, group users can post messages in the group account, send emails or texts to group members, etc., relating to the request. For the former, the user can send reminders, at step 312, to group members who have not made payment to the group account, such as through the group account page, email, text, or other means.

FIG. 3B shows a process 320 in which an administrator or other user can send money to group members through the group account, according to one embodiment. At step 322, the user selects a desired group, similar to step 302 in FIG. 3A. Next, the user selects group members to receive money, such as from the group account, at step 324, and an amount at step 326, which can be similar to steps 304 and 306, respectively, of FIG. 3A.

The user may also include a message to the selected group recipients at step 328. The message may include a reason for the payment, such as if the group account is “over-funded,” in which group members may receive an equal payment or based on the amount each member has paid into the account and/or time the member has been part of the group account. Other examples include a partial refund because a group purchase turned out to be less than the requested amount, one or more group members provided a “loan” to the group account, etc.

In addition, the message may also include information about how the group member can retrieve the payment. In one embodiment, a link is provided, which the group member can select to retrieve the payment. In another embodiment, the group member is instructed to access a web page and follow instructions included in the message or at the web page to retrieve the payment. This process, in one embodiment, is handled by the payment provider.

When group members pick up or retrieve the money, this activity can be tracked, at step 330. The user may be notified when members retrieve the money and/or the group account may be updated to reflect a decrease in the group account from a withdrawal by a group member.

FIG. 3C shows a process 340 in which a group member uses funds from the group account to make a payment, according to one embodiment. At step 342, the user selects a payee. The payee may be a merchant, retailer, charity, organization, individual, or any other recipient of money. In one example, the payee is selected or identified through an on-line purchase process, where one or more items are selected from a particular merchant or retailer. In another example, the payee is selected in a donation process through a charitable organization or site.

Once the payee is selected, the user proceeds to a checkout, at step 344. Checkout may be the point of the transaction where the user is ready to make the payment. For a purchase of goods or services, this may include placing the desired items in a cart and selecting a checkout or other similar button or link. For a donation, checkout may include selecting or entering an amount of the donation, followed by selecting a “continue,” “donate,” or other similar button or link. Other types of payment transactions are also suitable and may involve similar or different steps.

Next, a funding source for the payment needs to be determined. At step 346, the user selects the group account as the funding source. In one embodiment, when the user is ready to pay, the user selects the payment provider as the funding source. The user is then directed to a page from the payment provider, and the user is asked to log into the user's account if not already logged on. Once logged on, the user may be shown a list of possible funding sources within the user's account, such as a personal account and one or more group accounts. The user selects the desired group, such as by clicking on it, checking a box, or other method. This instructs the payment provider to make the payment to the payee from the selected group account. Note that the user implicitly has authority to make and authorize a payment from the group account. In one embodiment, the user is an administrator of the group account.

The payment is then made at step 348, assuming there are sufficient funds available in the group account. The payment provider debits the proper amount and credits the payee's account with that amount. The payee may have an account with the payment provider or with another financial provider, such as a bank. The payment provider receives the necessary information through the checkout process or other means, such as the payee providing a user name or other identifier, an account number, etc.

Once payment has been made, the group members may be notified at step 350. Notification can be through email, text, or other means. An email may be sent to group members informing them that a payment from the group account has been made, along with a description of the payment if desired. The amount of the payment may also be included in the notification. It should be noted that the various steps where group members are notified may be individually through the group member's individual contact information or through a group contact, such as a group email address. A short text may also be used as the notification.

Notification lets group members know that the group account has changed, e.g., a reduction in the amount of funds available due to the payment. Thus, group members may view the account, at step 352, such as by logging into their account and accessing the group account or accessing the group account directly. The group account may show the payment was made, who the payee was, the amount of the payment, and the date of the payment, along with any other descriptors, such as ones added by the user making the payment or other group members.

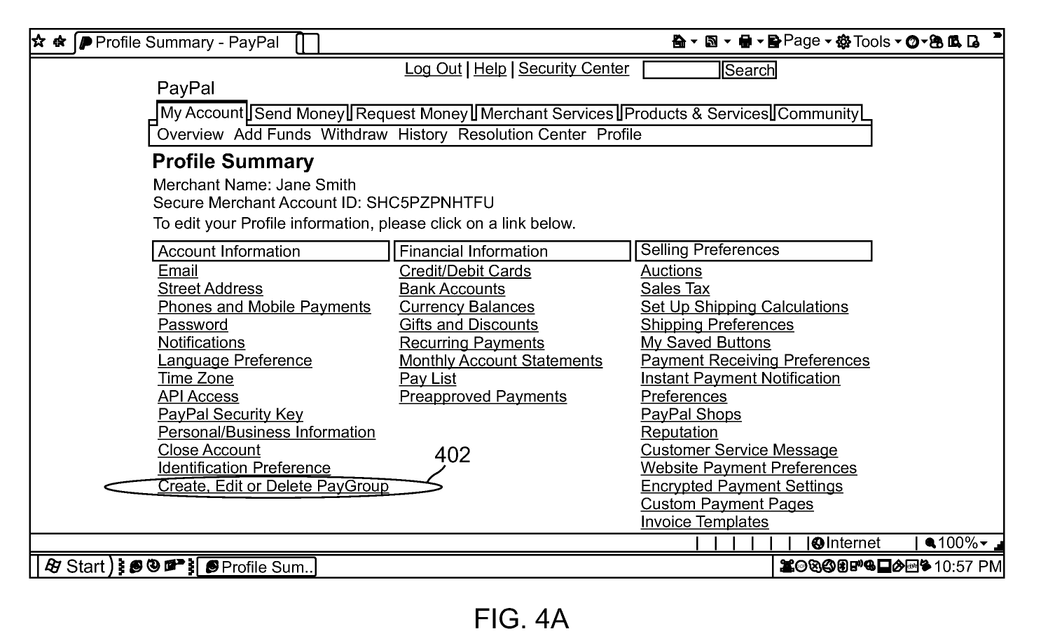

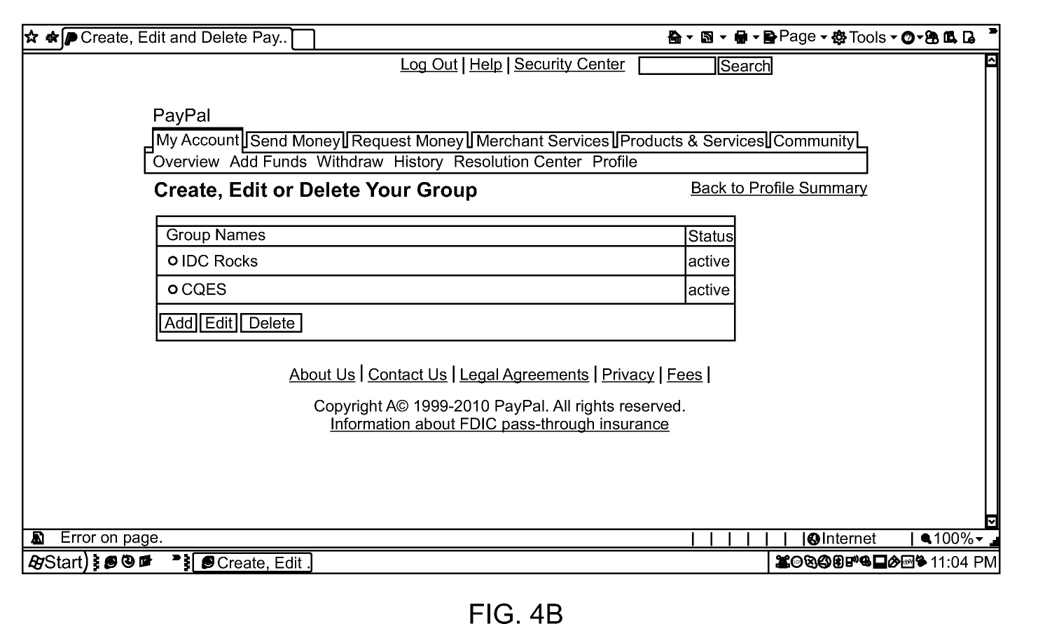

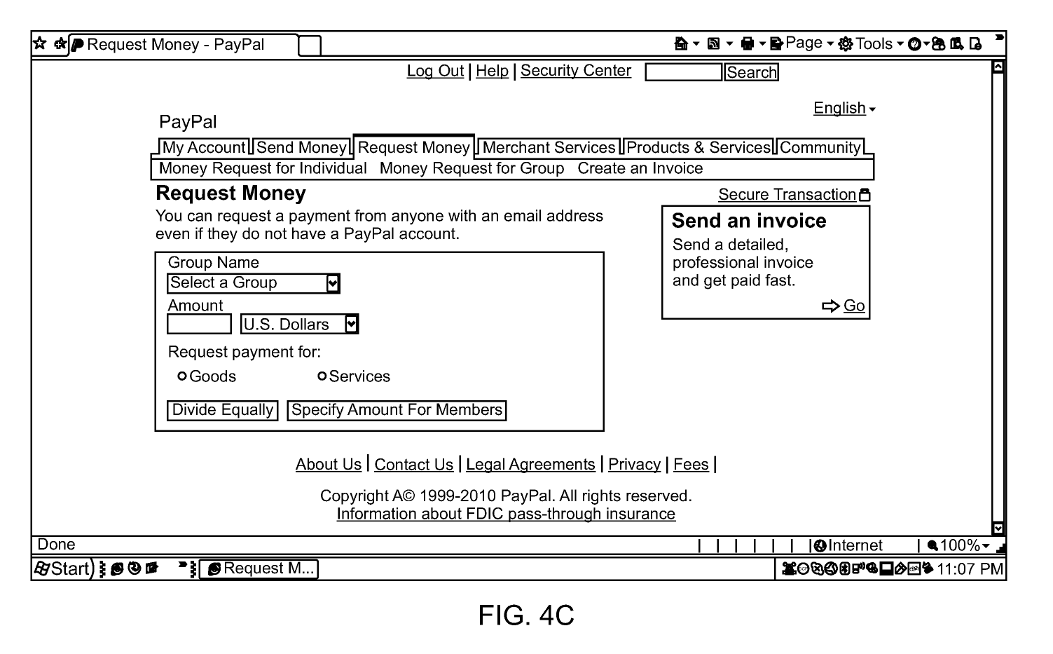

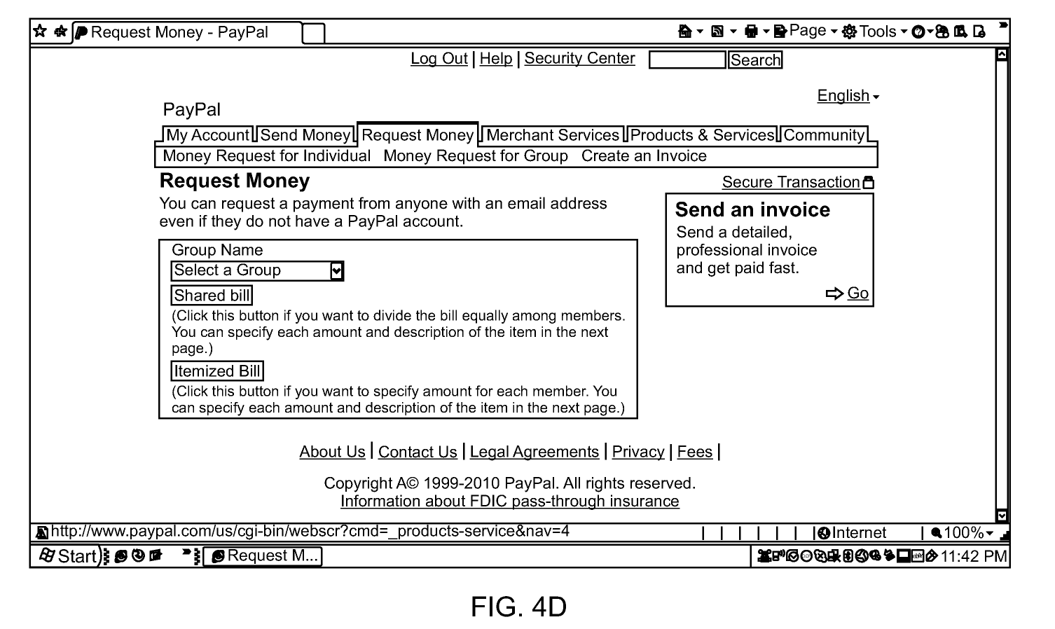

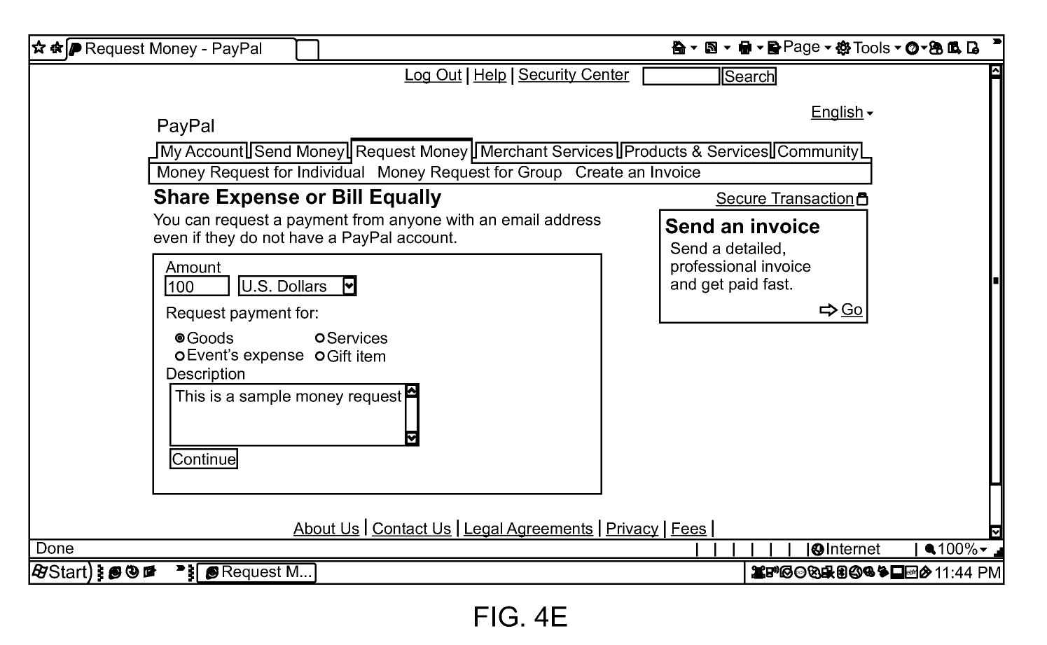

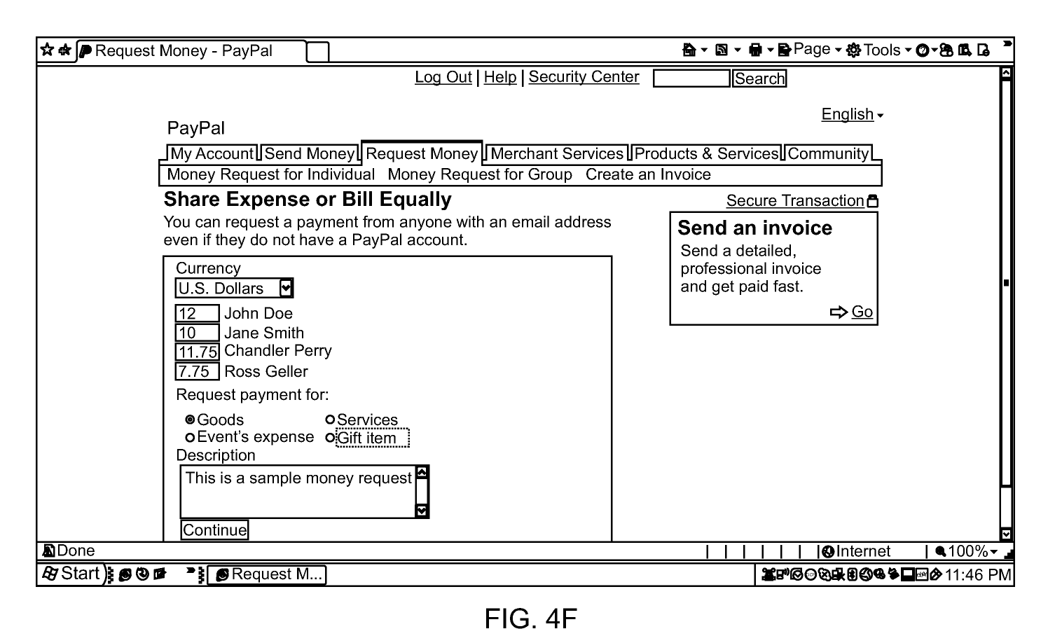

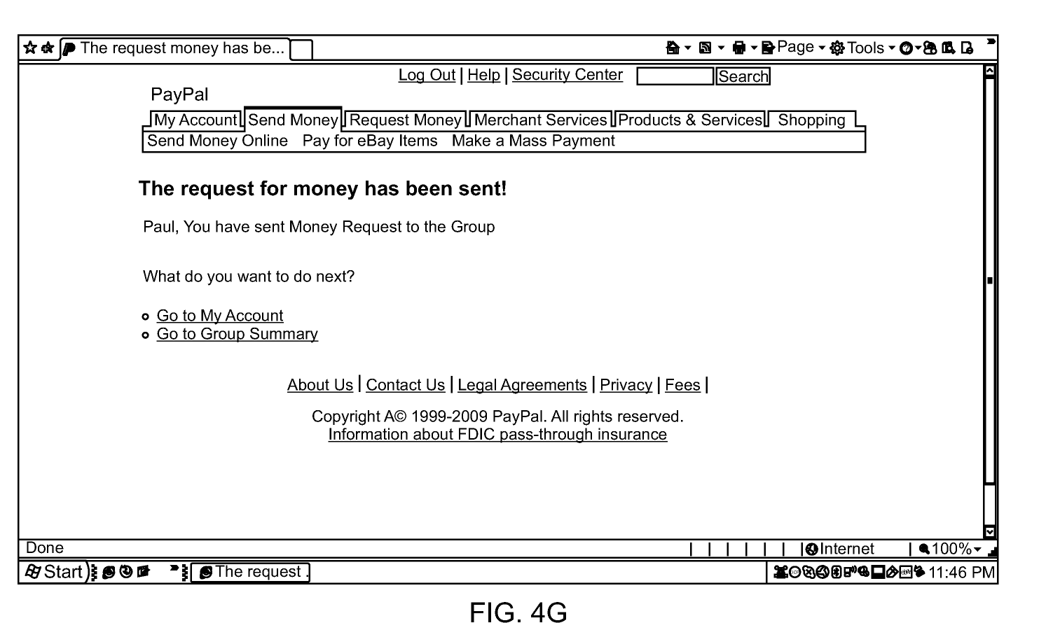

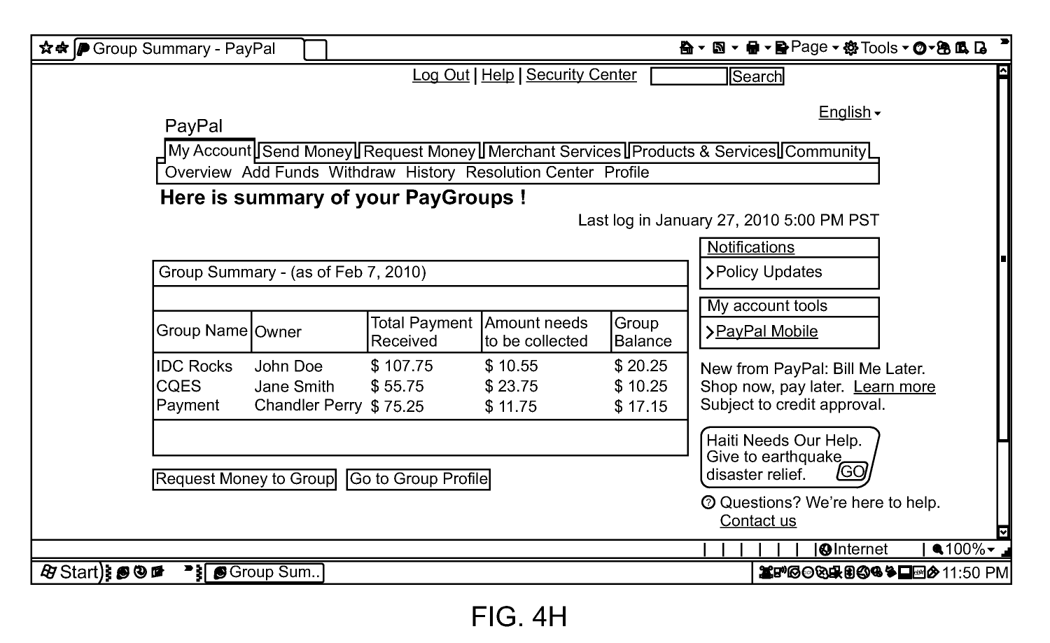

FIGS. 4A-4H are exemplary screen shots seen by a user for creating and administering a financial group account according to one embodiment. FIG. 4A shows an account page of the user after the user has accessed or logged in the user's account with the payment provider. In the user's account or home page, a link 402 is provided, which the user can select to create, edit, or delete a financial group account.

FIG. 4B shows the page the user sees after clicking on link 402. In this example, the user sees two financial groups, both of which have an “active” status. The user may select a desired group by clicking on a field next to the name of the group. If the user wishes to add or create a new group, the user can simply select the “Add” button, without selecting a pre-existing group, to be directed to a page for creating a new financial group. If the user wishes to perform an action with a pre-existing group, the user selects an action, such as “Edit” to edit the selected group (for example, adding or deleting members) or “Delete” to delete the selected group.

FIG. 4C shows a screenshot when the user wants to request money or request a collection from the group. From the home page, the user selects the “Request Money” tab and then “Money Request for Group.” The page allows the user to select the desired group for collecting the money from, using a drop down menu showing the user available groups. The user can also enter the amount to be collected and select the type of currency from a drop down menu. In this example, the user may select what the payment is for, goods or services, although other types may also be available, such as charity. This page also enables the user to specify how the requested money will be distributed, such as equally among the group members or specified amounts for members. For the former, the user may select all or some of the group members for equal division. For the latter, the user may select desired group members and enter the amount next to each group member.

FIGS. 4D-4F show screenshots when the user wants to request money or request a collection from the group, different than in FIG. 4C. In FIG. 4D, after the user selects the “Money Request for Group” tab, the user can select the desired group from a drop down menu and select how the money will be divided. One link is for equal distribution among group members and another link is for itemized or specified amounts for different members.

FIG. 4E is a screenshot when the user selects the equal distribution link. The user can enter the total amount requested and select a currency from a drop down menu. A category for the request can also be selected, and the user can enter a message with further details about the request or any other information. In another embodiment, all group members are shown such that the user can select which members to share equally in the request, since there may be situations when not all group members should share in the purchase. One example is if the purchase is specific for only a sub-set of the group.

FIG. 4F is a screenshot when the user selects the itemized amounts link. A currency type is selectable from a drop down menu. A list of group members is shown, along with a field where the user can enter a specific amount to be requested from that member. If nothing will be requested from a particular member, the user may enter zero. As with FIG. 4E, the user can also select a category for the request and enter any information for the group.

FIG. 4G shows a confirmation on the user's page with the payment provider that the request for money has been sent to the selected group members. The page also gives the user the option of going back to the user's account page or to go to a summary page of the group account.

FIG. 4H is a screenshot of a group summary page. The summary page provides the date of the summary, as well as a list of all the groups the user is associated with or an administrator for. For each group listed, the owner, administrator, or creator of the group is shown, along with total amount received, the amount that still needs to be collected, and the current balance in the group account. In different embodiments, the user can select the group, owner, total payment received, amount to be collected, and group balance to get more information, such as a detailed transaction history.

Thus, the group financial account or pay group provides on-line users a valuable tool for managing and performing financial transactions within and for a group of known members. The group account also provides a social aspect to financial transactions among a group sharing a common interest or simply a group of friends. There may be more users signing up and using services provided by the payment provider hosting the group account, and there may be additional money spent, both in quantity and volume, from purchases, donations, and other transactions from a group.

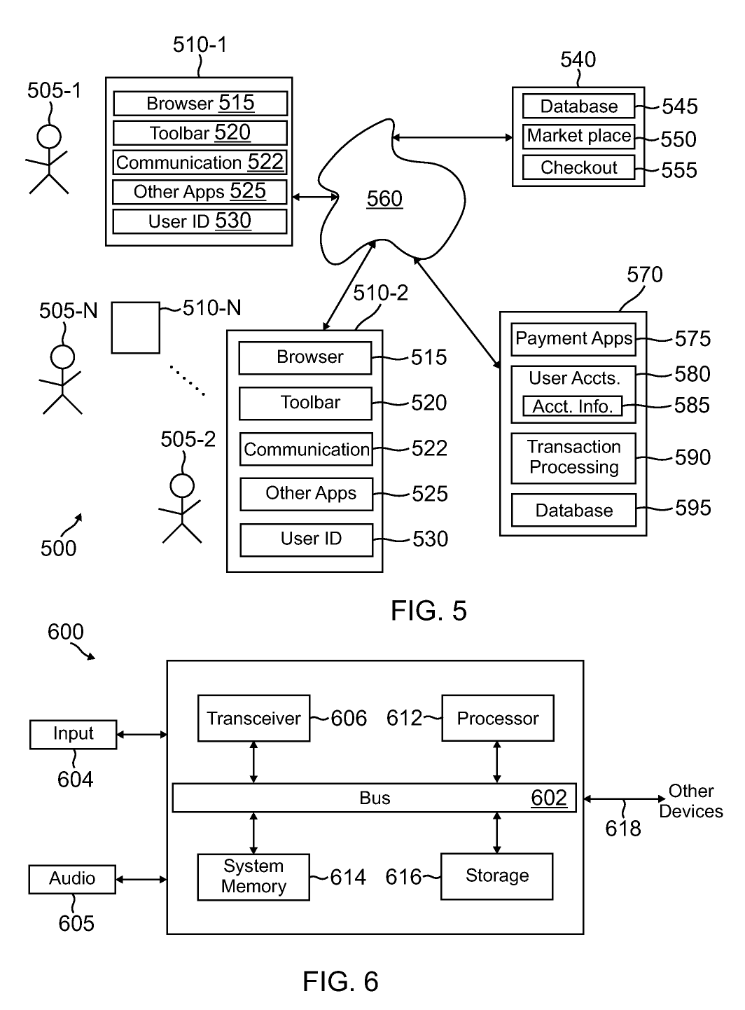

FIG. 5 is a block diagram of a networked system 500 configured to handle a financial transaction between members of a group financial account, such as described above, in accordance with an embodiment of the invention. System 500 includes a first user device 510-1, a second user device 510-2, an Nth user device 510-N, a merchant server 540, and a payment service provider server 570 in communication over a network 560. Payment service provider server 570 may be maintained by a payment provider, such as PayPal, Inc. of San Jose, Calif. A first user 505-1 utilizes and is associated with first user device 510-1, a second user 505-2 utilizes and is associated with second user device 510-2, and an Nth user 505-N utilizes and is associated with Nth user device 510-N for performing transactions with a payment provider. Note that in different embodiments, N can be zero or three on up, where N is the number of members of the group (N-1 if the administrator is not an actual member, but solely an administrator). In this example, user 505-1, 505-2, and 505-N may be members of the group account, with first user 505-1 being an administrator of the group account.

First user device 510-1, second user device 510-2, Nth user device 510-N, merchant server 540, and payment service provider server 570 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

Network 560 may be implemented as a single network or a combination of multiple networks. For example, in various embodiments, network 560 may include the Internet or one or more intranets, landline networks, wireless networks, and/or other appropriate types of networks.

First user device 510-1, second user device 510-2, and Nth user device 510-N may be implemented using any appropriate hardware and software configured for wired and/or wireless communication over network 560. For example, in one embodiment, the two user devices may be implemented as a personal computer (PC), a smart phone, personal digital assistant (PDA), laptop computer, and/or other types of computing devices capable of transmitting and/or receiving data, such as an iPad™ from Apple™.

First user device 510-1 may include one or more browser applications 515 which may be used, for example, to provide a convenient interface to permit first user 505-1 to browse information available over network 560. For example, in one embodiment, browser application 515 may be implemented as a web browser configured to view information available over the Internet. First user device 510-1 may also include one or more toolbar applications 520 which may be used, for example, to provide client-side processing for performing desired tasks in response to operations selected by first user 505-1. In one embodiment, toolbar application 520 may display a user interface in connection with browser application 515 as further described herein for viewing and/or managing a group account.

First user device 510-1 may further include other applications 525 as may be desired in particular embodiments to provide desired features to first user device 510-1. For example, other applications 525 may include security applications for implementing client-side security features, programmatic client applications for interfacing with appropriate application programming interfaces (APIs) over network 560, or other types of applications. Applications 525 may also include email, texting, voice and IM applications that allow first user 505-1 to send and receive emails, calls, and texts through network 560, as well as access a group account through links as discussed above. First user device 510-1 includes one or more user identifiers 530 which may be implemented, for example, as operating system registry entries, cookies associated with browser application 515, identifiers associated with hardware of first user device 510-1, or other appropriate identifiers, such as used for payment/user/device authentication. In one embodiment, user identifier 530 may be used by a payment service provider to associate first user 505-1 with a particular account maintained by the payment service provider as further described herein. A communications application 522, with associated interfaces, enables first user device 510-1 to communicate within system 500.

Second user device 510-2 may have similar applications and modules as first user device 510-1, but is associated with a member, but not an administrator, of the group account. Second user device 510-2 may also include one or more browser applications 515 and one or more toolbar applications 520 which may be used, for example, to provide a convenient interface to permit second user 505-2 to browse information and perform tasks over network 560. For example, in one embodiment, browser application 515 may be implemented as a web browser configured to view information available over the Internet and communicate with merchant server 540 to receive and send information about purchases made through merchant server 540.

Second user device 510-2 may further include other applications 525 such as security applications for implementing client-side security features, programmatic client applications for interfacing with appropriate application programming interfaces (APIs) over network 560, or other types of applications. Applications 525 may also include email, text, IM, and voice applications that allow second user 505-2 to communicate through network 560 and access the group account and the payment provider, such as via links. Second user device 510-2 includes one or more user identifiers 530 which may be implemented, for example, as operating system registry entries, cookies associated with browser application 515, identifiers associated with hardware of second user device 510-2, or other appropriate identifiers, such as used for payment/user/device authentication, e.g., the phone number associated with second user device 510-2. Identifiers may be used by a payment service provider to associate second user 505-2 with a particular account maintained by the payment service provider.

Nth user device 510-N and any other user devices associated with users of the group account have similar applications as second user device 510-2. However, not all user devices need to be the same. For example, one user device may be a smart phone, another user device may be a laptop computer, and another user device may be a desktop PC.

Merchant server 540 may be maintained, for example, by an on-line merchant offering various products and/or services in exchange for payment to be received over network 560. Merchant server 540 includes a database 545 identifying available products and/or services (e.g., collectively referred to as items) which may be made available for viewing and purchase by one or more of users 505-1, 505-2, to 505-N. Merchant server 540 also includes a marketplace application 550 which may be configured to serve information over network 560 to browser 515 of the user devices. In one embodiment, first user 505-1 may interact with marketplace application 550 through browser applications over network 560 in order to view various products or services identified in database 545, such as for purchasing for the group.

Merchant server 540 also includes a checkout application 555 which may be configured to facilitate the purchase by first user 505-1 of goods or services identified by marketplace application 550. Checkout application 555 may be configured to accept payment information from first user 505 through payment service provider server 570 from funds in a group financial account. For example, checkout application 555 may receive and process a payment confirmation from payment service provider server 570, as well as transmit transaction information to the payment provider and receive information from the payment provider (e.g., a transaction ID). Checkout application 555 may also enable payment through other user devices in communication with the payment provider.

Payment service provider server 570 may be maintained, for example, by an online payment service provider which may provide payment between one or more of users 505-1, 505-2, to 505-N, and the operator of merchant server 540. Payment service provider server 570 includes one or more payment applications 575 which may be configured to interact with user devices 510-1, 510-2, to 510-N and/or merchant server 540 over network 560 to facilitate the purchase of goods or services by one or more users using a group financial account.

Payment service provider server 570 also maintains a plurality of user accounts 580, each of which may include account information 585 associated with individual users. For example, account information 585 may include private financial information of users of devices such as account numbers, passwords, device identifiers, user names, phone numbers, credit card information, bank information, or other financial information which may be used to facilitate online transactions by one or more users. Advantageously, payment application 575 may be configured to interact with merchant server 540 on behalf of a user during a transaction with checkout application 555 to track and manage purchases made by users of the group account.

A transaction processing application 590, which may be part of payment application 575 or separate, may be configured to receive information from a user device and/or merchant server 540 for processing and storage in a payment database 595. Transaction processing application 590 may include one or more applications to process information from a user to determine the recipient and sender of funds and the amount of funds to be transferred. Other funding sources may also be processed through this application. Payment application 575 may be further configured to determine the existence of accounts for users, as well as create new accounts if necessary.

Note that in different embodiments, system 500, merchant server 540 is not needed, as user devices may communicate directly with each other and with payment service provider server 570 to process payment requests and transfers between users or members of the group financial account. One example is if user 505-2 and 505-N are requested to contribute money to the group account by user 505-1. Users 505-2 and 505-N may then communicate with payment service provider server 570, which then processes the payments for the group account.

FIG. 6 is a block diagram of a computer system 600 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons or links, etc., and sends a corresponding signal to bus 602. I/O component 604 may also include an output component, such as a display. An optional audio input/output component 605 may also be included to allow a user to use voice for inputting information by converting audio signals. Audio I/O component 605 may allow the user to hear audio. A transceiver 606 transmits and receives signals between computer system 600 and other devices, such as another user device, a merchant server, or a payment provider server. In one embodiment, the transmission is wireless, although other transmission mediums and methods may also be suitable. A processor 612, which can be a micro-controller, digital signal processor (DSP), or other processing component, processes these various signals, such as for display on computer system 600 or transmission to other devices via a communication link 618. Processor 612 may also control transmission of information, such as cookies or IP addresses, to other devices.

Components of computer system 600 also include a system memory component 614 (e.g., RAM) and a static storage component 616 (e.g., ROM). Computer system 600 performs specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media includes optical or magnetic disks, volatile media includes dynamic memory, such as system memory component 614, and transmission media includes coaxial cables, copper wire, and fiber optics, including wires that comprise bus 602. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, steps in the various flowcharts have been shown and described sequentially. However, the steps do not need to be performed in the described order, but can be in different orders, omitted, or combined as desired. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method of performing financial transactions, comprising:
receiving, by a processor of a payment provider, a request for a financial transaction from a member of an on-line financial group;
determining, by the processor, whether the request is for a deposit to or a withdrawal from an account of the financial group; and
transferring funds from an account of one or more members of the financial group if the request is for a deposit or transferring funds from the account of the financial group if the request is for a withdrawal.

2. The method of claim 1, wherein the member making the request is an administrator of the financial group.

3. The method of claim 1, further comprising notifying, by the processor, one or more payers, wherein the payers are members of the financial group.

4. The method of claim 3, wherein the notifying is by email or text.

5. The method of claim 1, further comprising updating a web page hosted by the payment provider when the account of the financial group changes.

6. The method of claim 5, wherein the web page is viewable by all members of the financial group.

7. The method of claim 1, further comprising receiving a request from a user to create the on-line financial group.

8. The method of claim 7, wherein the request to create comprises information identifying invitees to join the financial group.

9. The method of claim 1, wherein the request is for members of the financial group to deposit money into the account of the financial group for a financial transaction using the account of the financial group.

10. The method of claim 9, wherein the transaction is for a purchase, a donation, or a payment.

11. The method of claim 1, wherein the request is for members of the financial group to receive money from the account of the financial group.

12. The method of claim 1, wherein the account of the financial group is accessed through the payment provider.

13. The method of claim 12, wherein the access is through individual accounts of members of the financial group.

14. The method of claim 1, wherein a web page showing the account of the financial group and the account of the financial group are managed by the payment provider.

15. A machine-readable medium comprising a plurality of machine-readable instructions which when executed by one or more processors of a server are adapted to cause the server to perform a method comprising:
receiving, by a payment provider, a request for a financial transaction from a member of an on-line financial group;
determining whether the request is for a deposit to or a withdrawal from an account of the financial group, wherein the account is managed by the payment provider; and
transferring funds from an account of one or more members of the financial group if the request is for a deposit or transferring funds from the account of the financial group if the request is for a withdrawal.

16. The machine-readable medium of claim 15, wherein the method further comprises notifying one or more payers, wherein the payers are members of the financial group.

17. The machine-readable medium of claim 15, wherein the method further comprises hosting, by the payment provider, a web page where members of the financial group can view information about the account.

18. The machine-readable medium of claim 15, wherein the method further comprises receiving a request from a user to create the on-line financial group, wherein the request comprises information identifying invitees to join the financial group.

19. The machine-readable medium of claim 15, wherein the request is for members of the financial group to deposit money into the account of the financial group for a financial transaction using the account of the financial group.

20. The machine-readable medium of claim 15, wherein the request is for members of the financial group to receive money from the account of the financial group.

21. The machine-readable medium of claim 17, wherein the web page is accessed through individual accounts of members of the financial group.

22. An electronic payment processing system comprising:
means for receiving a request for a financial transaction from a member of an on-line financial group;
means for determining whether the request is for a deposit to or a withdrawal from an account of the financial group, wherein the account is managed by the payment provider; and
means for transferring funds from an account of one or more members of the financial group if the request is for a deposit or transferring funds from the account of the financial group if the request is for a withdrawal.

23. A method of performing financial transactions, comprising:
receiving, by a processor of a payment provider, a request for a financial transaction from a member of an on-line financial group; and
transferring funds from an account of one or more members of the financial group to an account of the on-line financial group if the request is for a deposit.

24. A method of performing financial transactions, comprising:
receiving, by a processor of a payment provider, a request for a financial transaction from a member of an on-line financial group; and
transferring funds from the account of the financial group to an account of one or more members of the financial group if the request is for a withdrawal.
